(19) United States
(12) Patent Application Publication
(10) Pub. No.: US 2026/0066404 A1
(43) Pub. Date: Mar. 5, 2026

(54) AEROSOL-GENERATING SYSTEM WITH ADHESIVE BETWEEN ELECTRODE UNIT AND ENVELOPE

(71) Applicant: Philip Morris Products S.A., Neuchatel (CH)

(72) Inventors: Guoqiang CAI, Shenzhen (CN); Hongjie XU, Hong Kong (HK); Kai WANG, Zhuhai (CN); XuQing TANG, Zhangwanzhen (CN); Sheng LI, Zhangwanzhen (CN)

(73) Assignee: Philip Morris Products S.A., Neuchatel (CH)

(21) Appl. No.: 19/106,004

(22) PCT Filed: Aug. 31, 2022
(86) PCT No.: PCT/CN2022/116094

§ 371 Date: Feb. 24, 2025

(51) Int. Cl. H01M 50/124; A24F 40/465; A24F 40/70; H01M 10/0587; H01M 50/247

(52) U.S. Cl. CPC H01M 50/1245; A24F 40/465; A24F 40/70; H01M 10/0587; H01M 50/247; H01M 2220/30

(57) ABSTRACT

An aerosol-generating system is provided, including: a battery including an electrode component and a packaging for the electrode component; and an adhesive element provided in between the electrode component and the packaging, the packaging including a packaging layer and a protective layer, the protective layer being arranged in between the packaging layer and the electrode component, the protective layer being electrically non-conductive, the adhesive element being in contact with the protective layer, the protective layer being provided with an adhesive or including adhesive, and the adhesive of the protective layer being configured to increase its adhesive force during heating in manufacturing of the battery from an initial value that is lower than an adhesive force of the adhesive element. A method of manufacturing a battery for an aerosol-generating system is also provided.

The present invention relates to an aerosol-generating system with a battery. The present invention also relates to a method for manufacturing an aerosol-generating system and a use of an adhesive in an aerosol-generating system.

Known handheld electrically operated aerosol-generating systems typically comprise an aerosol-generating device comprising a battery, control electronics and an electric heating element for heating an aerosol-generating article designed specifically for use with the aerosol-generating device. Some aerosol-generating systems comprise a companion device, such as a charging device, for holding the aerosol-generating device.

In prior art aerosol-generating devices, pouch batteries are used to enable a compact design. However, pouch batteries in handheld electrically operated smoking systems may suffer from broken electrode tabs and accelerated ageing, since electrodes are movably enclosed in the soft pouch casing and the aerosol-generating device is susceptible regarding impacts, when being dropped by a consumer. Increasing the mechanical robustness through rigid packaging would lead to an increase in the size of the battery. As a consequence, either user experience is reduced by increasing the size of the aerosol-generating device, or the battery life may decrease.

It would be preferable to provide an aerosol-generating device with a battery that has a relatively long life and yet is small enough to be used in a highly compact aerosol-generating device.

According to a first aspect of the invention, there is provided an aerosol-generating system comprising a battery. The battery comprises an electrode unit and an envelope. An adhesive element is provided in between the electrode unit and the envelope.

According to a second aspect of the invention, there is provided a method of manufacturing a battery for an aerosol-generating system, wherein an electrode unit is provided. An adhesive element may be attached to on an outer surface of the electrode unit. An envelope may be arranged around the electrode unit, such that the adhesive element is in contact with the envelope.

The aerosol-generating system may comprise an aerosol-generating device.

The aerosol-generating system may comprise an aerosol-generating device and a companion device. The companion device may be a charging device or a charging case for the aerosol-generating device. The aerosol-generating device may be mechanically couplable to the companion device. The companion device may be arranged or may be adapted to receive the aerosol-generating device.

The companion device may comprise a receiving cavity for receiving a part of or the entire aerosol-generating device therein.

The battery may be located within the aerosol-generating device or the companion device.

The battery may be located within the aerosol-generating device, and the system may further comprise one or more second batteries located within the companion device. The one or more second batteries may comprise an electrode unit and an envelope with an adhesive element provided in between the electrode unit and the envelope.

The one or more second batteries may be at least one of identical in structure, identical in shape and/or identical in material to the battery in/for the aerosol-generating device. The one or more second batteries may be bigger in size and/or have a higher storage capacity to enable for several charging cycles of the aerosol-generating device's battery.

The companion device may comprise an electrical connection port for engaging with an electrical connection port of the aerosol-generating device, preferably to charge the aerosol-generating device's battery.

The adhesive element may enable the electrode unit to be fixed to the envelope.

The adhesive element may be for limiting movement of the electrode unit with respect to the envelope.

The adhesive element may comprise one or ore more of a styrene-isoprene block copolymer, an acrylate, a silicone rubber, and a polydimethylsiloxane (PDMS). The modified polypropylene may have an initial adhesion force greater or equal 0.1 Newton per millimeter, and after heating, in particular hot-pressing, greater or equal 0.3 Newton per millimeter. The adhesive material may withstand high temperatures up to 30 to 40 degrees Celsius. The adhesive material may be anti-corrosive.

The electrode unit may be formed of one or more electrode assemblies. Each electrode assembly comprises two electrodes, in particular a cathode and an anode, and a separator arranged in between the electrodes.

The electrodes and the separator may be in form of a sheet material. The separator may be a single layer of polymer material. The separator may comprise a plurality of layers of polymer material.

The electrode unit further comprises an electrolyte. The electrolyte may be disposed between the electrodes and the separator.

The one or more electrode assemblies may be wound around a longitudinal direction to form a plurality of windings. The adhesive element may be arranged to at least connect the last winding with the second-last winding.

The main extension direction of the electrode unit, namely the direction in which the electrode unit has its greatest length, may be in a longitudinal direction. A transversal direction may be perpendicular to the longitudinal direction. A circumferential direction may be defined around the longitudinal direction. In an upright orientation of the aerosol-generating device, the longitudinal direction may be a height direction and the transversal direction may be a horizontal direction. Any indications in the following regarding “upper”, “top”, “lower” and “bottom” are with respect to the longitudinal direction being the height direction.

The electrode unit may have the shape of, or may be referred to as, a jellyroll.

The electrode unit may have a thickness of 2 millimeters to 12 millimeters, in particular in between 7 millimeters to 9 millimeters, and preferably in between 8 millimeters to 9 millimeters.

The electrode unit may have a width of 10 millimeters to 50 millimeters, in particular in between 15 millimeters to 30 millimeters, and preferably in between 23 millimeters to 24 millimeters,

The electrode unit may have a length of 20 millimeters to 80 millimeters, in particular in between 45 to 70 millimeters, and preferably in between 55 millimeters to 60 millimeters. The electrode assemblies may be stacked along the transversal direction. The adhesive element may be arranged on an outer side of the electrode unit, preferably on a circumferential face of the electrode unit.

The adhesive may be arranged on a circumferential face of the electrode unit.

The adhesive element may be arranged on a longitudinal end face of the electrode unit. The adhesive element may be connected to the circumferential face, so as to connect or compress the electrode unit.

The adhesive strip or adhesive pad may apply a clamping force to the electrode unit, thereby enabling the electrode assemblies or windings or both electrode assemblies and windings of the electrode unit to be connected. Connecting electrode assemblies or windings or both electrode assemblies and windings may extend the battery life by avoiding local peaks in the current density of the electrodes due to the movement of the electrode assemblies or windings or both electrode assemblies and windings.

The adhesive element may be in the form of an adhesive strip or adhesive pad. The electrode unit may be provided with at least two tabs, wherein the tabs extend from the longitudinal end face of the electrode unit. The adhesive element may be arranged in between the tabs.

The tabs may extend through a longitudinal end face of the envelope.

In particular, the tabs enable the flow of electric current to or from the electrode. The tab may be integrally formed with or directly attached to the electrode.

In particular, the battery comprises at least two terminals, wherein at least a portion of the terminals is accessible from outside of the envelope for connecting the electrode unit to an electrical circuit of the aerosol generating device.

In particular, each the cathode and the anode is provided with one or more tabs, and wherein a first terminal is attached or integrally connected to the one or more tabs of the cathode and a second terminal is attached or integrally connected to the one or more tabs of the anode.

The adhesive may be in contact with the electrode.

The adhesive may extend across an edge of the longitudinal end face of the electrode unit.

The adhesive may be in contact with the envelope.

The adhesive element may be in the form of a glue spot.

The adhesive element may comprise a substrate layer. The substrate layer may be at least partially coated with adhesive. The substrate layer may comprise polyethylene terephthalate (PET) and/or polyimide. This can improve resistance to high temperatures.

At least a portion of at least one side of the substrate layer may be coated with the adhesive.

The adhesive element may be a double-sided adhesive element. At least a portion of each side of the substrate layer may be coated with the adhesive. The first coated side portion may be in contact with the electrode unit, preferably with a circumferential face of the electrode unit. The second coated side portion may be in contact with the envelope.

The double-sided adhesive element may have a thickness of 0.01 millimeters to 0.07 millimeters, in particular in between 0.02 millimeters to 0.5 millimeters, and preferably in between 0.03 to 0.04 millimeters.

The double-sided adhesive element may have a width of 5 millimeters to 40 millimeters, in particular in between 10 millimeters to 30 millimeters, and preferably in between 15 millimeters to 25 millimeters.

The double-sided adhesive element may have a length of 20 millimeters to 80 millimeters, in particular in between 30 millimeters to 70 millimeters, and preferably in between 42 millimeters to 48 millimeters.

The aerosol generating system may further comprise a second adhesive element. The second adhesive element may be attached across a longitudinal end face of the electrode unit so to connect or squeeze the electrode unit. The second adhesive element may be arranged between tabs of the electrode unit, on the bottom longitudinal end face of the electrode unit, or on an edge of the upper longitudinal end face of the electrode unit.

The second adhesive element may be a single-sided adhesive element.

The second adhesive element may have a thickness of 5 micrometers to 30 micrometers, in particular in between 10 micrometers to 20 micrometers, and preferably in between 14 micrometers to 18 micrometers.

The second adhesive element may have a width of 5 millimeters to 40 millimeters, in particular in between 10 millimeters to 25 millimeters, and preferably in between 13 millimeters to 17 millimeters.

The second adhesive element may have a length greater than 25 millimeters, in particular in between 25 millimeters to 50 millimeters, and preferably in between 28 millimeters to 40 millimeters.

The envelope may be a packaging for the electrode unit.

The envelope may partially or fully enclose the electrode unit.

At least an edges of the envelope may be sealed.

The envelope may comprise a protective layer and a packaging layer, wherein the protective layer is arranged in between the packaging layer and the electrode unit. The adhesive may be in contact with the protective layer. The protective layer may be electrically non-conductive.

The packaging layer may be made of a soft or flexible or soft and flexible material, such as a foil.

The packaging layer may comprise one or ore more of a modified polypropylene acrylate, a silicone rubber, and a polydimethylsiloxane (PDMS). The modified polypropylene may have an initial adhesion force of greater equal 0.1 Newton per millimeter, and after heating, in particular hot-pressing, of greater equal 0.3 Newton per millimeter.

The protective layer may be provided with an adhesive or includes adhesive. The adhesive of the protective layer may be less adhesive than the adhesive of the adhesive element.

The adhesive of the protective layer or adhesive element or protective layer and adhesive element may comprise a styrene-isoprene block copolymer, wherein the styrene-isoprene block copolymer are composed of a hard segment and a soft segment. A higher ratio of the soft segment to the hard segment, may provide a stronger adhesive force. The ratio of the soft segment to the hard segment in the protective layer may be lower than in the adhesive element.

After heating, preferably hot-pressing, the adhesive force of the protective layer may increase to be in the range of about 10 percent of the adhesive force of the adhesive element.

The adhesive of the protective layer may be activatable at temperatures above ambient temperature, preferably at a temperature in between 50 degrees Celsius to 300 degrees Celsius, in particular in between 70 degrees Celsius to 150 degrees Celsius.

The adhesive of the protective layer may have a smaller adhesion force than the adhesive of the adhesive element. The smaller adhesion force may facilitates assembly of the battery, in particular wrapping the electrode unit with the adhesive element in the envelope.

An intermediate layer may be provided between the packaging layer and the protective layer. The protective layer may comprise polypropylene, the intermediate layer may comprise aluminum and the packaging layer may comprise nylon.

In some examples, the envelope may comprise three, four, five or more layers. The layers of the envelope from the outer layer towards the inner layer, which is in contact with the electrode unit, may be two or more of: a nylon layer, an adhesive layer, a moisture impermeable layer including aluminum, an adhesive layer, and a non-conductive layer comprising polypropylene, in the respective order.

The outer side of the electrode unit may partially or fully be formed by an electrode.

The battery may be configured to supply power for aerosol generation.

The battery may be configured to supply power to a heating element for aerosol generation.

The battery may be a pouch battery, preferably with a cylindrical or prismatic shape.

The battery maybe a secondary battery, in particular a lithium secondary battery comprising at least on of: a lithium-nickel-manganese-cobalt oxide, a lithium iron phosphate, a lithium nickel-cobalt-aluminum oxide, and a lithium-cobalt oxide.

In other examples, the battery may comprise at least one of: a lithium iron phosphate, a lithium a nickel-cobalt-aluminum oxide, a lithium-cobalt oxide, a lithium-manganese oxide, a lithium-nickel-manganese oxide, and a lithium-manganese-cobalt oxide. In yet other examples, the battery may comprise at least one of: a lithium sulphur; a lithium metals. In yet other examples, the battery may be a sodium secondary battery or a solid-state battery.

The method may further comprise inserting the electrode unit in the envelope.

The method may further comprise wrapping the envelope around the electrode unit. The battery may comprise a protective layer and a packaging layer, wherein the protective layer may be wrapped to face the electrode unit.

The method may further comprise heating the battery so that the protective layer increases its adhesive properties. The battery may be heated above ambient temperature, preferably in between 50 degrees Celsius to 300 degrees Celsius, in particular in between 70 degrees Celsius to 150 degrees Celsius.

The method may further comprise sealing an opening for the tabs of the envelope.

The method may further comprise attaching a second adhesive element across a longitudinal end face of the electrode unit so to connect or squeeze the electrode unit. The second adhesive element may be arranged between tabs of the electrode unit, on the bottom longitudinal end face of the electrode unit, or on an edge of the upper longitudinal end face of the electrode unit.

The second adhesive element may be a single-sided adhesive element. The second adhesive element may have a thickness of 5 micrometers to 30 micrometers, in particular in between 10 micrometers to 20 micrometers, and preferably in between 14 micrometers to 18 micrometers.

The second adhesive element may have a width of 5 millimeters to 40 millimeters, in particular in between 10 millimeters to 25 millimeters, and preferably in between 13 millimeters to 17 millimeters.

The second adhesive element may have a length greater than 25 millimeters, in particular in between 25 millimeters to 50 millimeters, and preferably in between 28 millimeters to 40 millimeters.

The electrode unit may be formed of one or more electrode assemblies, comprising two electrodes, in particular a cathode and an anode, and a separator arranged in between the electrodes, the electrodes and the separator may be in form of a sheet material, and wherein providing the electrode unit, may comprise at least one of winding the one or more electrode assemblies around the longitudinal direction to form a plurality of windings or stacking the electrode assemblies the transversal direction.

The method may further comprise connecting the last with the second-last winding with the adhesive element, preferably, by arranging the adhesive element so to overlap between the last and the second-last winding on a circumferential face of the electrode unit.

The aerosol-generating system or aerosol-generating device may be for generating an aerosol comprising nicotine.

The aerosol-generating system may comprise an aerosol-generating device and an aerosol-generating article comprising an aerosol-generating substrate comprising nicotine.

According to a third aspect of the invention, there is provided a use of an adhesive element between an electrode unit and an envelope in an aerosol-generating device to attach the electrode unit to the envelope.

The invention is defined in the claims. However, below there is provided a non-exhaustive list of non-limiting examples and embodiments. Any one or more of the features of these examples may be combined with any one or more features of another example, embodiment, or aspect described herein.

Example Ex1: An aerosol-generating system comprising a battery, wherein the battery comprises an electrode unit and an envelope, wherein an adhesive element is provided in between the electrode unit and the envelope.

Example Ex2: The aerosol-generating system according to Ex1, wherein the electrode unit is formed of one or more electrode assemblies, comprising two electrodes, in particular a cathode and an anode, and a separator arranged in between the electrodes.

Example Ex3: The aerosol-generating system according to Ex2, wherein the electrodes and the separator is in form of a sheet material.

Example Ex4: The aerosol-generating system according to any one of examples Ex1 to Ex3, The electrode unit further comprises an electrolyte.

Example Ex5: The aerosol-generating system according to Ex4, wherein the electrolyte is disposed between the electrodes and the separator.

Example Ex6: The aerosol-generating system according to any one of the preceding examples, wherein the one or more electrode assemblies is wound around a longitudinal direction to form a plurality of windings, and wherein the adhesive element is arranged to at least connect the last winding with the second-last winding.

Example Ex7: The aerosol-generating system according to any one of the preceding examples, wherein the electrode unit has the shape of a jellyroll.

Example Ex8: The aerosol-generating system according to any one of any one of examples Ex2 to Ex7, wherein the electrode assemblies are stacked along a transversal direction, and wherein the adhesive element is arranged on an outer side of the electrode unit, preferably on a circumferential face of the electrode unit.

Example Ex9: The aerosol-generating system according to any one of the preceding examples, wherein the adhesive is arranged on a circumferential face of the electrode unit.

Example Ex10: The aerosol-generating system according to any one of the preceding examples, wherein the adhesive element is arranged on a longitudinal end face of the electrode unit, wherein the adhesive element is connected to the circumferential face, so to connect or compress the electrode unit.

Example Ex11: The aerosol-generating system according to any one of the preceding examples, wherein the adhesive element is in the form of an adhesive strip or adhesive pad.

Example Ex12: The aerosol-generating system according to any one of the preceding examples, wherein the electrode unit is provided with at least two tabs, wherein the tabs extend from the longitudinal end face of the electrode unit, and wherein the adhesive element is arranged in between the tabs.

Example Ex13: The aerosol-generating system according to example Ex12 any one of the preceding examples, wherein the tabs extend through a longitudinal end face of the envelope.

Example Ex14: The aerosol-generating system according to any one of examples Ex2 to Ex13, wherein the battery comprises at least two terminals, wherein at least a portion of the terminals is accessible from outside of the envelope for connecting the electrode unit to an electrical circuit of the aerosol generating system.

Example Ex15: The aerosol-generating system according to any one of the preceding examples, wherein each the cathode and the anode is provided with one or more tabs, and wherein a first terminal is attached and/or collects the one or more tabs of the cathode and a second terminal is attached and/or collects the one or more tabs of the anode.

Example Ex16: The aerosol-generating system according to any one of the preceding examples, wherein the adhesive is in contact with the electrode.

Example Ex17: The aerosol-generating system according to any one of any one of examples Ex2 to Ex16, wherein the adhesive extends across an edge of the longitudinal end face of the electrode unit.

Example Ex18: The aerosol-generating system according to any one of the preceding examples, wherein the adhesive is in contact with the envelope.

Example Ex19: The aerosol-generating system according to any one of the preceding examples, wherein the adhesive element is in the form of a glue spot.

Example Ex20: The aerosol-generating system according to any one of the preceding examples, wherein the adhesive element comprises a substrate layer, wherein the substrate layer is at least partially coated with adhesive.

Example Ex21: The aerosol-generating system according to example Ex20, wherein at least a portion of at least one side of the substrate layer is coated with the adhesive.

Example Ex22: The aerosol-generating system according to any one of the preceding examples, wherein at least a portion of each side of the substrate layer is coated with the adhesive, wherein the first coated side portion is in contact with the electrode unit, preferably with a circumferential face of the electrode unit, and the second coated side portion is in contact with the envelope.

Example Ex23: The aerosol-generating system according to any one of the preceding examples, wherein the envelope is a packaging for the electrode unit.

Example Ex24: The aerosol-generating system according to any one of the preceding examples, wherein the envelope partially or fully enclose the electrode unit.

Example Ex25: The aerosol-generating system according to any one of the preceding examples, wherein edges of the envelope is sealed.

Example Ex26: The aerosol-generating system according to any one of the preceding examples, wherein the envelope comprises a protective layer and a packaging layer, wherein the protective layer is arranged in between the packaging layer and the electrode unit, and wherein the adhesive is in contact with the protective layer, wherein the protective layer is electrically non-conductive, and optionally, wherein the protective layer is provided with an adhesive or includes adhesive, wherein the adhesive of the protective layer has less adhesive force than the adhesive of the adhesive element.

Example Ex27: The aerosol-generating system according to any one of the preceding examples, wherein the packaging layer is made of a soft and/or flexible material, such a foil, in particular aluminum foil.

Example Ex29: The aerosol-generating system according to any one of examples Ex26 to Ex29, wherein the adhesive of the protective layer is activatable at a temperatures above ambient temperature, preferably at a temperature in between 50 degrees Celsius to 300 degrees Celsius, in particular in between 70 degrees Celsius to 150 degrees Celsius.

Example Ex30: The aerosol-generating system according to any one of the preceding examples, wherein the outer side of the electrode unit is partially or fully formed by an electrode.

Example Ex31: The aerosol-generating system according to any one of the preceding examples, wherein the battery is configured to supply power for aerosol generation.

Example Ex32: The aerosol-generating system according to any one of the preceding examples, wherein the battery is configured to supply power to a heating element for aerosol generation.

Example Ex33: The aerosol-generating system according to any one of the preceding examples, wherein the battery is a pouch battery, preferably with a cylindrical or prismatic shape.

Example Ex34: The aerosol-generating system according to any one of the preceding examples, wherein the aerosol-generating system comprises an aerosol-generating device.

Example Ex35: The aerosol-generating system according to any one of the preceding examples, wherein the aerosol-generating system comprises an aerosol-generating device and a companion device.

Example Ex36: The aerosol-generating system according to the preceding example, wherein the companion device is a charging device or a charging case for the aerosol-generating device.

Example Ex37: The aerosol-generating system according to any one of the preceding examples Ex36 to Ex37, wherein the aerosol-generating device is mechanically couplable to the companion device.

Example Ex38: The aerosol-generating system according to any one of the preceding examples Ex36 to Ex38, wherein the companion device is arranged or adapted to receive the aerosol-generating device.

Example Ex39: The aerosol-generating system according to the preceding example, wherein the companion device comprises a cylindrical receiving cavity defined within a proximal portion of the companion device for receiving a least a distal portion of the aerosol-generating device therein.

Example Ex40: The aerosol-generating system according to any one of the preceding examples, wherein the battery is located within the aerosol-generating device or the companion device.

Example Ex41: The aerosol-generating system according to any one of the preceding examples Ex35 to Ex39, wherein the battery is located within the aerosol-generating device, and the aerosol-generating system further comprises one or more second batteries located within the companion device.

Example Ex42: The aerosol-generating system according to the preceding example, wherein the one or more second batteries comprise an electrode unit and an envelope with an adhesive element provided in between the electrode unit and the envelope.

Example Ex43: The aerosol-generating system according to the preceding example, wherein the one or more second batteries are at least one of identical in structure, identical in shape and/or identical in material to the battery in/for the aerosol-generating device.

Example Ex44: The aerosol-generating system according to the preceding example, wherein the one or more second batteries are bigger in size and/or have a higher storage capacity to enable for several charging cycles of the battery used in the aerosol-generating device.

Example Ex45: The aerosol-generating system according to any one of the preceding examples Ex35 to Ex44, wherein the companion devices comprise an electrical connection port for engaging with an electrical connection port of the aerosol-generating device, preferably to charge the battery used in the aerosol-generating device.

Example Ex46: The aerosol-generating system according to any one of the preceding examples further comprises a second adhesive element, wherein the second adhesive element is attached across a longitudinal end face of the electrode unit so to connect or squeeze the electrode unit.

Example Ex47: The aerosol-generating system according to the preceding example, wherein the second adhesive element is arranged between the tabs of the electrode unit, on the bottom longitudinal end face of the electrode unit, or on an edge of the upper longitudinal end face of the electrode unit.

Example Ex48: The aerosol-generating system according to any one of the preceding examples Ex45 to Ex47, wherein the second adhesive element is a single-sided adhesive element.

Example Ex49: A method of manufacturing a battery for an aerosol-generating system, comprising the steps of:
providing an electrode unit,
attaching an adhesive element on an outer surface of the electrode unit,
arranging an envelope around the electrode unit, such that the adhesive element is in contact with the envelope.

Example Ex50: The method according to example Ex49 further comprises inserting the electrode unit in the envelope.

Example Ex51: The method according to any one of examples Ex49 to Ex50, wherein arranging the envelope around the electrode unit comprises wrapping the envelope around the electrode unit, wherein the battery comprises a protective layer and a packaging layer, the protective layer facing the electrode unit.

Example Ex52: The method according to any one of examples Ex49 to Ex51, further comprises heating the battery so that the protective layer increases its stickiness.

Example Ex53: The method according to example Ex52, wherein the battery is heated above ambient temperature, in particular in between 70 degrees Celsius to 150 degrees Celsius, preferably in between 50 degrees Celsius to 300 degrees Celsius, in particular in between 70 degrees Celsius to 150 degrees Celsius.

Example Ex54: The method according to any one of examples Ex49 to Ex53 further comprises sealing an opening for the tabs of the envelope.

Example Ex55: The method according to any one of examples Ex49 to Ex54 further comprises attaching a second adhesive element across a longitudinal end face of the electrode unit so to connect or compress the electrode unit, wherein the second adhesive element is arranged between tabs of the electrode unit, on the bottom longitudinal end face of the electrode unit, or on an edge of the upper longitudinal end face of the electrode unit.

Example Ex56: The method according to any one of the preceding examples, wherein the electrode unit is formed of one or more electrode assemblies, comprising two electrodes, in particular a cathode and an anode, and a separator arranged in between the electrodes, the electrodes and the separator is in form of a sheet material.

Example Ex57: The method according to any one of examples Ex49 to Ex56, wherein providing the electrode unit comprises wounding the one or more electrode assemblies around a longitudinal direction to form a plurality of windings.

Example Ex58: The method according to any one of examples Ex49 to Ex56, further comprises connecting the last with the second-last winding with the adhesive element, preferably, by arranging the adhesive element so to overlap between the last and the second-last winding on a circumferential face of the electrode unit.

Example Ex59: Use of an adhesive element between an electrode unit and an envelope in an aerosol-generating system to fix the electrode unit to the envelope.

The method according to examples Ex49 to Ex58 may be performed with the system according to examples Ex1 to Ex57. The system according to examples Ex1 to Ex57 may be used according to example Ex59.

Examples will now be further described with reference to the figures.

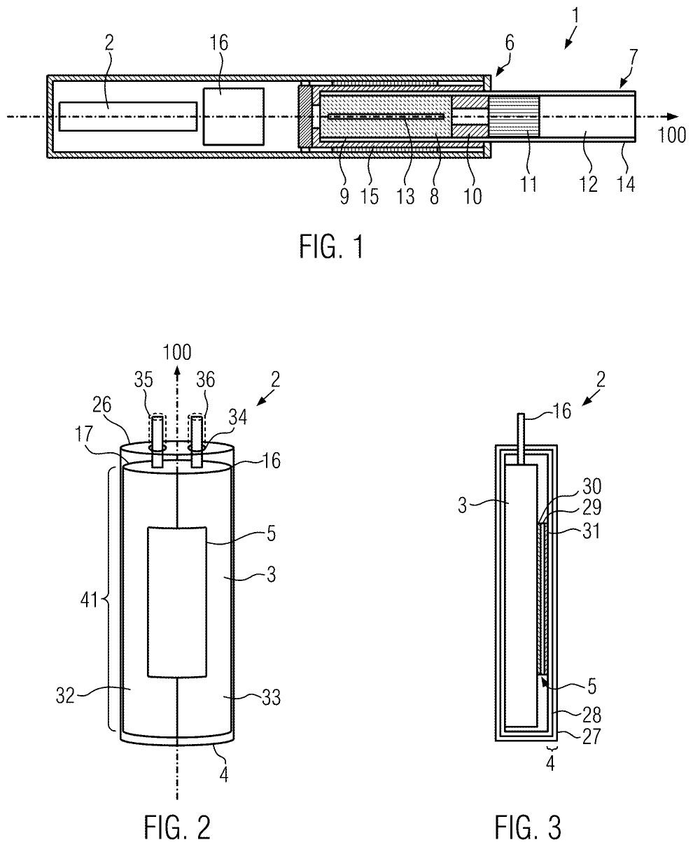

FIG. 1 shows a schematic cross-sectional view of an embodiment of an aerosol-generating system according to an embodiment of the invention.

FIG. 2 shows a schematic perspective view of a battery in the upright orientation for a first embodiment of the aerosol-generating system according to FIG. 1.

FIG. 3 shows a schematic cross-sectional view of the battery according to FIG. 2.

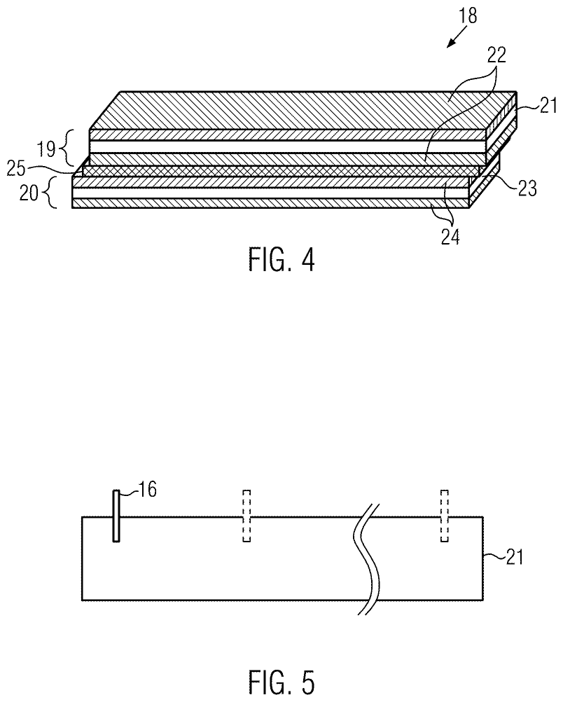

FIG. 4 shows a schematic side view of an unrolled electrode.

FIG. 5 shows a schematic top view of an unrolled electrode having one or more tabs, which may be used in the battery according to FIG. 2 or FIG. 3.

FIG. 6 shows a schematic perspective view of a battery for a second embodiment of the aerosol-generating system according to FIG. 1.

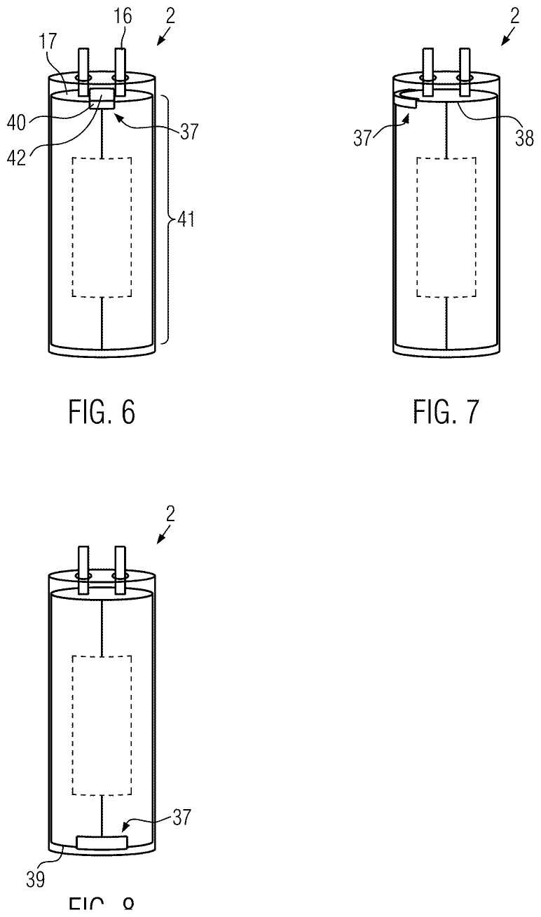

FIG. 7 shows a schematic perspective view of a battery for a third embodiment of the aerosol-generating system according to FIG. 1.

FIG. 8 shows a schematic perspective view of a battery for a fourth embodiment of the aerosol-generating system according to FIG. 1.

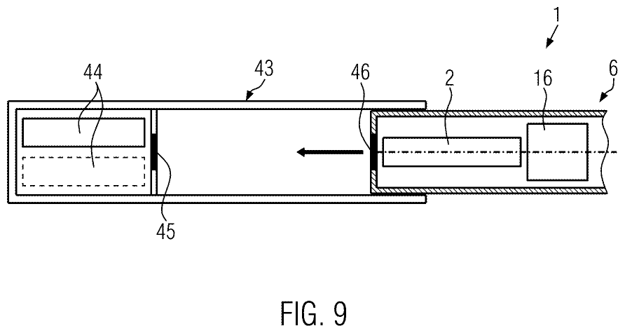

FIG. 9 shows a cross-sectional view of a companion device in form of a charging case for a fifth embodiment of the aerosol-generating system according to FIG. 1.

Referring to FIGS. 1 to 4, an aerosol-generating system 1 according to first embodiment of the invention is described in conjunction with a battery 2 having an electrode unit 3 and an envelope 4 for the electrode unit 3. An adhesive element 5 is provided in between the electrode unit 3 and the envelope 4 for fixing the electrode unit 3 to the envelope.

FIG. 1 schematically shows the aerosol-generating system 1 in a lying position, with the longitudinal axis 100 extending in the horizontal direction. The aerosol-generating system 1 comprises the aerosol-generating device 6 as well as an aerosol-generating article 7 for use with the aerosol-generating device 1. The aerosol-generating article 7 comprises an aerosol-generating substrate 8 to be heated to form an inhalable aerosol. The aerosol-generating article 7 is a consumable comprising four segments sequentially arranged in coaxial alignment: an aerosol-forming rod segment 9, a support segment 10 having a central air passage, an aerosol-cooling segment 11 and a mouthpiece segment 12 comprising a filter. The aerosol-forming rod segment 9 is arranged at a distal end of the article 7 and comprises a susceptor 13 and the aerosol-generating substrate 8 to be heated. The mouthpiece segment 12 is arranged at a proximal end of the article 7. The support segment 10 and the aerosol-cooling segment 11 are arranged in between. Each of the four segments may a substantially cylindrical element with substantially the same diameter to establish a rod-shape of the aerosol-generating article. The four segments may be circumscribed by an outer wrapper 14 to connect the four segments. The wrapper 14 may be made of paper.

The aerosol-generating device 6 comprises a cylindrical receiving cavity defined within a proximal portion of the aerosol-generating device 6 for receiving a least a distal portion of the article 7 therein. The aerosol-generating device 6 further comprises a heating element 15 with an inductor for generating an alternating high-frequency magnetic field. In the present embodiment, the inductor may be a helical coil circumferentially surrounding the cylindrical receiving cavity. In alternative embodiments, the heating element may be an electrical resistance heating means. The coil is arranged such that the susceptor 13 of the aerosol-generating article 7 is exposed to the alternating magnetic field upon engaging the article 7 with the device 1. Thus, when activating the heating element 15, the susceptor 13 heats up due to eddy currents and hysteresis losses that are induced by the alternating magnetic field within the susceptor 13, depending on its magnetic and electric material properties. The susceptor 13 is heated until reaching an operating temperature sufficient to vaporize the aerosol-generating substrate 8 surrounding the susceptor 13 within the article 7. Within a distal portion, the aerosol-generating device 6 further comprises a battery 2 and power supply electronics 16 for powering and controlling the heating process.

In use of the aerosol-generating system 1, when a consumer draws on the mouthpiece element 12 of the article 7, air is drawn into the receiving cavity at the rim of the cavity. The air flow further extends towards the distal end of the cavity through a passage which is formed between the inner surface of the cylindrical cavity and the outer surface of the article 7. At the distal end of the cavity, the air flow enters the aerosol-generating article 7 through the substrate element 9 and further passes through the support element 10, the aerosol cooling element 11 and the mouthpiece element 12, where it finally exits the article 7. In the substrate element 9, vaporized material from the aerosol-generating substrate 8 is entrained into the air flow. Subsequently, when passing through the support element 10, the cooling element 11 and the mouthpiece element 12, the air flow including the vaporized material cools down such as to form an inhalable aerosol escaping the article 7 through the mouthpiece element 12.

A more detailed illustration of the battery 2 of FIG. 1 is shown in FIGS. 2 to 3. FIG. 2 provides a perspective view of the battery 2 in an upright direction with the longitudinal axis 100 extending in the vertical direction. FIG. 3 shows a cross-sectional of the battery 2 of FIG. 2 while the battery 2 is rotated by 90 degrees.

As shown, the battery 2 comprises the electrode unit 3 and the envelope 4 with a cavity for housing the electrode unit 3.

The electrode unit 3 has the form of a jellyroll with a plurality of windings around the longitudinal axis 100. The electrode unit 3 comprises two or more tabs 16. The tabs 16 extend from the upper longitudinal end face 17 of the electrode unit 3.

The electrode unit 3 of FIGS. 2 and 3 is formed of one or more electrode assemblies that are stacked or rolled along the longitudinal axis 100.

FIG. 4 shows and example electrode assembly 18 which forms the electrode unit 3 according to FIGS. 2 and 3 in an unrolled state.

The electrode assembly 18 comprises two electrodes, namely a cathode 19 and an anode 20.

The cathode 19 is formed of multilayer sheet material. The multilayer sheet material of the cathode 19 comprises a cathode current collector layer 21. The cathode current collector layer 21 is formed of a sheet material and comprises two opposing large surfaces. The cathode current collector layer 21 is coated on both surfaces with a cathode active material, such that a cathode active material layer 22 is formed on both surfaces of cathode current collector layer 21. In some examples, only one surface of cathode current collector layer 21 may be coated with the cathode active material. Similar to the cathode 19, the anode 20 is formed of a multilayer sheet material. The multi-layer sheet material of the anode 20 comprises an anode current collector layer 23. The anode current collector layer 23 is formed of a sheet material and comprises two opposing large surfaces. The anode current collector layer 23 is coated on both surfaces with a cathode active material, such that an anode active material layer 24 is formed on both surfaces of anode current collector layer 23. In some examples, only one surface of the anode current collector layer 23 may be coated with the anode active material.

The electrode unit 3 further comprises a separator 25. The separator 25 is formed of a sheet material. The separator is provided in between the cathode 19 and the anode 20.

An example of the cathode current collector layer 21 is shown in FIG. 5 in top view. The vertical extension of the cathode current collector layer 21 as shown in FIG. 5 corresponds to the height of the electrode unit 3 shown in FIG. 2. The horizontal extension of the cathode current collector layer 21 corresponds to the length of the cathode current collector layer 21 and is perpendicular to the vertical extension.

The anode current collector layer 23 may be formed with a similar or equal structure as the cathode current collector layer 21.

The one or more tabs 16 of the electrode unit 3 as shown in FIG. 2 are provided on an edge of the cathode current collector layer 21 in a distance to each other.

Referring back to FIGS. 2 and 3, in a rolled state of the electrode assembly 18, the tabs extend from the upper longitudinal end face 17 of the electrode unit 3 through the upper longitudinal end face 26 of the envelope 4.

As shown in FIG. 3, the envelope 4 provides a cavity for the electrode unit 3 for protecting same from the surrounding outside the battery. The envelope 4 may be made of a soft material, such as a foil. In the present embodiment the envelope 4 fully encloses the electrode unit 3. Edges of the envelope 7 may be sealed to provide a waterproof packaging.

The envelope 4 comprises a packaging layer 27 and a protective layer 28. The protective layer 28 is arranged in between the packaging layer 27 and the electrode unit 3 and is made of an electrically non-conductive material. A side of the protective layer 28 facing the electrode unit 3 is provided with an adhesive.

In some examples, an intermediate layer (not shown) is provided between the packaging layer 27 and the protective layer 28. The protective layer comprises polypropylene, the intermediate layer comprises aluminum and the packaging layer comprises nylon.

In between the electrode unit 3 and the protective layer 28, there is provided the adhesive element 5.

The adhesive element 5 comprises a substrate layer 29 with a double-sided adhesive coating. A first coated side portion 30 adheres to the electrode unit 3 and the second coated side portion 31 adheres to the protective layer 28. The adhesive of the protective layer 28 has a smaller adhesion force than the adhesive of the adhesive element 5, which facilitates assembly of the battery 2, in particular wrapping the electrode unit 3 with the adhesive element 5 in the envelope 4.

The substrate layer 29 is in the form of a pad and is arranged to at least connect the last winding 32 with the second-last winding 33 of the electrode unit 3, which is in the form of a jelly roll. In other examples, the substrate layer 29 is in the form of a strip. In yet other examples, the adhesive element is a glue spot.

The envelope 4 further comprises openings 34 for receiving the tabs 16. In some examples, and is indicated in FIG. 2 with dashed lines, the battery 12 includes two terminals 35, 36 for connecting an electrical circuitry (e.g. a protection circuit module) of the aerosol-generating device 2. The terminals 35, 36 are provided on the same, preferably upper longitudinal end face 26 of the envelope 4.

The terminals 35, 36 are connected to the cathode 18 to provide a positive terminal and to the anode 19 to provide a negative terminal, respectively. The battery 2 may have a pouch-shape. Alternatively, the battery 2 may have a cylindrical shape. The terminals 35, 36 may be arranged on the same side of the battery 2. Alternatively, the terminals 35, 36 are provided on opposite longitudinal end faces.

In other examples, the tabs 16 are folded inside the envelope 4 and are attached to bottom end faces of the terminals 35, 36.

Referring to FIGS. 6 to 8, an aerosol-generating device 6 according to further embodiments of the invention is described. Instead or in addition to the battery 2 of the aerosol generating device 1 according to the first embodiment shown in FIGS. 1 to 4, the batteries 2 in FIGS. 6 to 8 are provided with a second adhesive element 37 between the envelope 4, particularly the protective layer 28, and the electrode unit 3.

The second adhesive element 37 may be arranged on at least one of on the upper longitudinal end face 26 of the envelope 4 between the tabs 16 of the electrode unit 3 (FIG. 6), on an edge 38 of the upper longitudinal end face 17 of the electrode unit 3 (FIG. 7), or on a bottom longitudinal end face 39 of the electrode unit 3 (FIG. 8).

The second adhesive element 37 comprises a substrate layer in form of a strip or pad. At least opposite end portions 40 of the substrate layer comprise an adhesive coating and adheres to a circumferential face 41 of the electrode unit 3 whereby a middle portion 42 between the end portions 40 of the second adhesive element 37 extends over a longitudinal end face 17, 39 of the electrode unit 3, thereby applying a clamping force to the electrode unit 3.

In some examples, the substrate layer of the second adhesive element 37 has a single-sided adhesive coating extending over an entire side that is connected to the electrode unit 3.

As schematically shown in FIG. 9, the aerosol-generating system 1 may further comprise a companion device 43 adapted to receive the aerosol-generating device 6 for charging the battery 2. In particular, the companion device 43 comprises a cylindrical receiving cavity defined within a proximal portion of the companion device 43 for receiving a least a distal portion of the aerosol-generating device 6 therein.

The companion device 43 comprises one or more second batteries 44. The one or more second batteries 44 comprise an electrode unit and an envelope with an adhesive element provided in between the electrode unit and the envelope, similar to the battery 2 shown with respect to FIGS. 2, 3 and 6 to 8. In some examples, the one or more second batteries may be bigger in size and/or have a higher storage capacity to enable for several charging cycles of the battery 2.

The companion device 43 comprises an electrical connection port 45 for engaging with a corresponding electrical connection port 46 of the aerosol-generating device 6 to transfer electric energy between the companion device 43 and the aerosol-generating device 1, preferably to charge the battery 2.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein.

1.-15. (canceled)

16. An aerosol-generating system, comprising:
a battery comprising an electrode unit and a packaging for the electrode unit; and
an adhesive element provided in between the electrode unit and the packaging,
wherein the packaging comprises a packaging layer and a protective layer,
wherein the protective layer is arranged in between the packaging layer and the electrode unit,
wherein the protective layer is electrically non-conductive,
wherein the adhesive element is in contact with the protective layer,
wherein the protective layer is provided with an adhesive or includes adhesive, and
wherein the adhesive of the protective layer is configured to increase its adhesive force during heating in manufacturing of the battery from an initial value that is lower than an adhesive force of the adhesive element.

17. The aerosol-generating system according to claim 16, wherein the electrode unit is formed of one or more electrode assemblies, comprising two electrodes, and a separator arranged in between the two electrodes.

18. The aerosol-generating system according to claim 17, wherein the two electrodes are a cathode and an anode.

19. The aerosol-generating system according to claim 17,
wherein the one or more electrode assemblies is wound around a longitudinal direction to form a plurality of windings, and
wherein the adhesive element is arranged to at least connect a last winding with a second-last winding.

20. The aerosol-generating system according to claim 17,
wherein the one or more electrode assemblies is stacked along a transversal direction, and
wherein the adhesive element is arranged on an outer side of the electrode unit.

21. The aerosol-generating system according to claim 20, wherein the adhesive element is arranged on a circumferential face of the electrode unit.

22. The aerosol-generating system according to claim 16,
wherein the adhesive element is arranged on a longitudinal end face of the electrode unit, and
wherein the adhesive element is connectable to the circumferential face, so as to connect or compress the electrode unit.

23. The aerosol-generating system according to claim 16,
wherein the electrode unit is provided with at least two tabs,
wherein the at least two tabs extend from a longitudinal end face of the electrode unit, and
wherein the adhesive element is arranged in between the at least two tabs.

24. The aerosol-generating system according to claim 17,
wherein the battery further comprises at least two terminals, and
wherein at least a portion of the at least two terminals is accessible from outside of the packaging to connect the electrode unit to an electrical circuit of the aerosol generating system.

25. The aerosol-generating system according to claim 16,
wherein the adhesive element comprises a substrate layer, and
wherein the substrate layer is at least partially coated with adhesive.

26. The aerosol-generating system according to claim 25,
wherein at least a portion of each side of the substrate layer is coated with the adhesive, and
wherein a first coated side portion is in contact with the electrode unit and a second coated side portion is in contact with the packaging.

27. The aerosol-generating system according to claim 26, wherein the first coated side portion is in contact with a circumferential face of the electrode unit.

28. The aerosol-generating system according to claim 26, wherein the adhesive of the protective layer has less adhesive force than the adhesive of the adhesive element.

29. The aerosol-generating system according to claim 16, further comprising an aerosol-generating article comprising an aerosol-generating substrate.

30. The aerosol-generating system according to claim 29, wherein the aerosol-generating substrate comprises nicotine.

31. A method of manufacturing a battery for an aerosol-generating system, comprising the steps of:
providing an electrode unit;
attaching an adhesive element on an outer surface of the electrode unit;
arranging a packaging for the electrode unit around the electrode unit, wherein the packaging comprises a packaging layer and an electrically non-conductive protective layer, wherein the packaging is arranged around the electrode unit such that the adhesive element is in contact with the protective layer, and wherein the protective layer is provided with an adhesive or includes adhesive; and
heating the adhesive of the protective layer to increase its adhesive force from an initial value that is lower than an adhesive force of the adhesive element.

32. The method according to claim 31,
further comprising attaching a second adhesive element across a longitudinal end face of the electrode unit so as to connect or compress the electrode unit,
wherein the second adhesive element is arranged between tabs of the electrode unit, on a bottom of the longitudinal end face of the electrode unit, or on an upper edge of the longitudinal end face of the electrode unit.

33. The method according to claim 31, further comprising using an adhesive element between an electrode unit of the battery and a packaging for the electrode unit of the battery in the aerosol-generating system to fix the electrode unit to the packaging.
